(19) United States
(12) Patent Application Publication
(10) Pub. No.: US 2007/0263103 A1
(43) Pub. Date: Nov. 15, 2007

(54) IMAGE-CAPTURING APPARATUS

(75) Inventor: Hirokazu MAEDA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/741,824

(22) Filed: Apr. 30, 2007

(30) Foreign Application Priority Data
May 1, 2006 (JP) 2006-127610

(51) Int. Cl. H04N 5/76

(52) U.S. Cl. 348/231.99

(57) ABSTRACT

An image-capturing apparatus is provided having a memory, a storage, and an image recorder. The memory is mounted in the image-capturing apparatus. The storage medium is detachable from the image-capturing apparatus. The image recorder stores image data in the memory when the storage medium is detached during storing the input image data into the storage medium.

### BACKGROUND OF THE INVENTION

1. Field of the Invention

The present invention relates to an image-capturing apparatus, in particular to the storage of an image file in a storage medium of the image-capturing apparatus.

2. Description of the Related Art

An image-capturing apparatus, for example a digital camera, converts a photography subject input from the lens to image data by utilizing the CCD/AFE. Image data is stored temporally in RAM, processed by a DSP, and then stored in a detachable external storage medium. On LCD, image data stored in a storage medium, a through image obtained through a lens, and information required for operating a digital camera are displayed on an LCD either automatically or according to the operation of the operation of a switch.

A storage medium that stores image data and is removable, i.e. external memory, may be removed from a digital camera or filled to capacity during storage. In either case, the process of storing image data can not be completed and image data is lost. The digital camera which has a backup device located outside of the digital camera body to prevent loosing the image data is disclosed in Japanese Unexamined Patent Publication (KOKAI) No. 2004-153369.

However, the provision of a backup device external to the digital camera requires a transmitter, which increases the size and power consumption of the digital camera. Moreover, it does not assure the completion of data storage into the backup device because a communication failure may occur during transmission.

### SUMMARY OF THE INVENTION

An object of the present invention is to provide an image-capturing apparatus that can avoid losing image data in the event the image data may not be stored in a storage medium.

The present invention is an image-capturing apparatus having a memory mounted therein, a storage medium detachable from the image-capturing apparatus, and an image recorder that stores image data in the memory when said storage medium is detached at the time image data is being input into said storage medium.

### BRIEF DESCRIPTION OF THE DRAWINGS

The objects and advantages of the present invention will be better understood from the following description, with reference to the accompanying drawings in which:

FIG. 1 is a block diagram showing the image-capturing apparatus as an embodiment of the present invention;

FIG. 2 is a flowchart showing the photographing process;

FIG. 3 is a flowchart showing the storing process;

FIG. 4 is a flowchart showing the initializing process; and

FIG. 5 is a flowchart showing the image restoration process;

### DESCRIPTION OF THE PREFERRED EMBODIMENTS

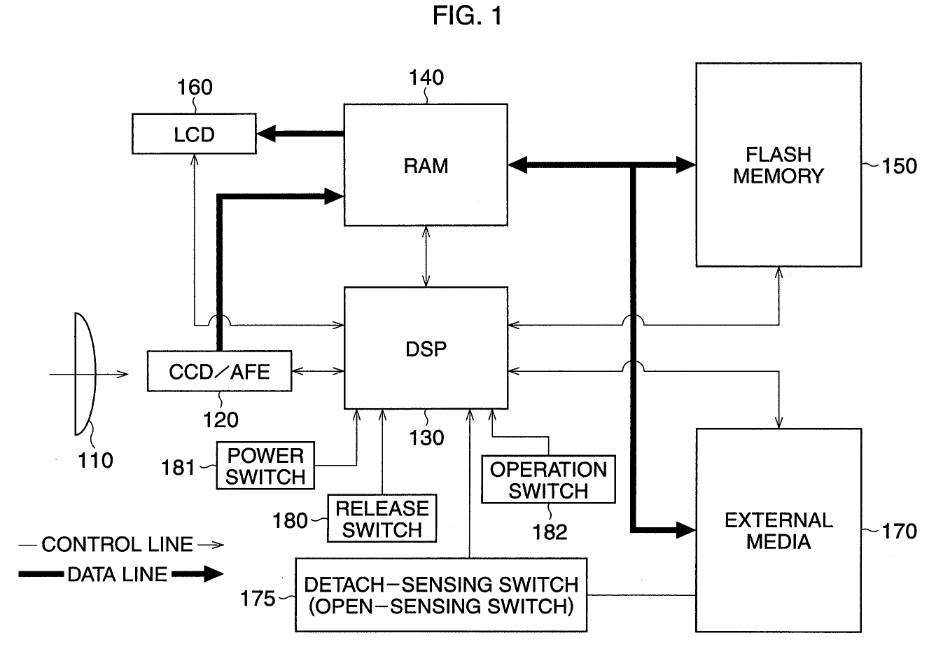

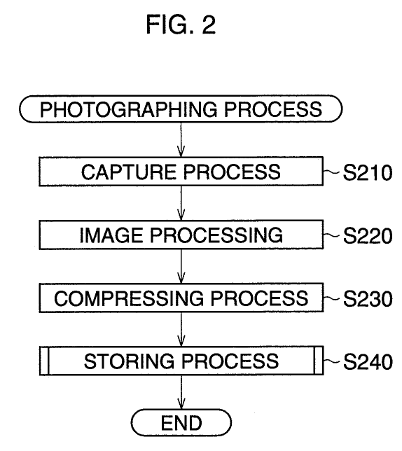

The present invention is described below with reference to the embodiments shown in the drawings. FIG. 1 is a block diagram showing a digital camera having an image-capturing apparatus that applies to the first embodiment of the present invention, and FIG. 2 is a flowchart showing the photographing process.

After the power supply of a digital camera is turned on, a DSP 130 prepares to take a picture by reading program and configuration information from a flash memory 150. The flash memory 150 is embedded in the digital camera and stores a program and a user's configuration data. The flash memory 150 comprises a non-volatile rewritable memory for example. A photography subject from a lens 110 is encoded to a digital signal by a CCD/AFE 120 and stored in a RAM 140 as image data. A LCD 160 displays the shooting information and the image data stored in the RAM 140.

The photographing process is described below. After a release switch 180 is operated, a capture process S210 is executed, in which the photography subject is input from the lens 110 into the CCD/AFE 120. The CCD/AFE 120 encodes the photography subject to the image data, and the image data is then stored in the RAM140. The DSP 130 processes the image data in step S220, and compresses it in step S230 by using JPEG compression for example. In step S240, the image data is stored in an external media 170. A detach-sensing switch 175 is positioned in the insert slot in which the external media 170 is inserted.

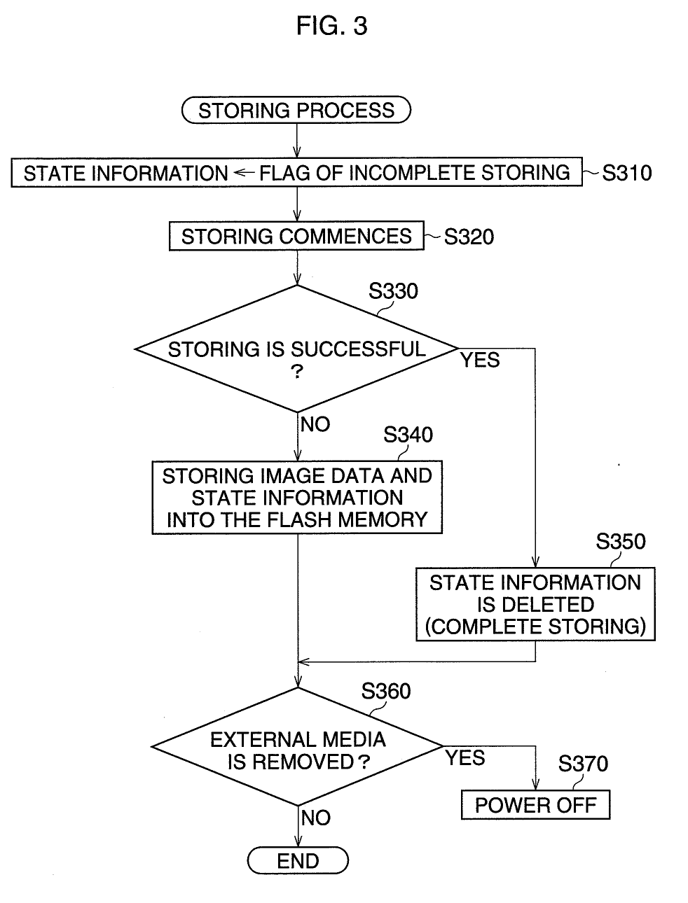

The storing process is described below with reference to FIG. 3. In step S310, state information is input and stored in the flash memory 150. State information is a flag which indicates whether storage is complete or if image data is to be stored in the external media 170. Then in step S320, storage of the image data into the external media 170 commences.

In step S330, the DSP 130 monitors whether storage of the image data is successful or not. A successful storage is confirmed by the DSP 130 with a signal which indicates the completion of the storing process, that is sent from the external media 170 or an element which controls the external media 170 (not shown in FIG. 3) to the DSP 130. Upon the completion of the storing process, that is to say when the DSP 130 receives the signal which indicates the storing process is completed; state information stored in the flash memory 150 is deleted in step S350. Failure in the storing process, that is to say when the DSP 130 does not receive the signal which indicates the completion of the storing process, the image data and state information are stored into the flash memory 150 in step S340.

In step S360, it is determined whether the failure of the storing process confirmed in step S330 was caused by the removal of the external media 170. IF the failure of the storage is caused by removal of the external media 170, the power supply of the digital camera is cut off in step S370. If the failure of the storage is not caused by removal of the external media 170, this process ends without cutting off the power.

It is determined whether the external media 170 is removed by using a detach-sensing switch 175 (refer to FIG. 1). A detach-sensing switch 175 detects mechanically whether the external media 170 is detached. When the detach-sensing switch 175 detects detachment of the external media 170, it transmits a signal indicating detachment through a control line to the DSP 130. The DSP 130 determines the external media 170 to be detached based on the received signal.

The storage of the image data may fail when either insufficient capacity exists in the external media 170, or the external media 170 is detached during the storing process. In step S330, the DSP 130 determined if a storage failure occurs based on whether or not it receives a signal that indicates completion of storage. Then, in step S340 the DSP 130 stores the image data and state information into the flash memory 150. In step S360, the DSP 130 determines whether or not the external media is detached, and if it not the process ends without cutting off the power.

Therefore, even if the image data is not stored in the external media 170, the image data is stored in the flash memory 150 without being lost.

After the storing process, the power supply of the digital camera is cut off and the external media 170 is replaced by a recordable external media when an unrecordable external media 170 is inserted into the digital camera. The unrecordable media has insufficient capacity or is a broken media. The recordable external media is inserted when the external media 170 is detached from the digital camera. As a result, the preparations for turning on the power supply of the digital camera are complete.

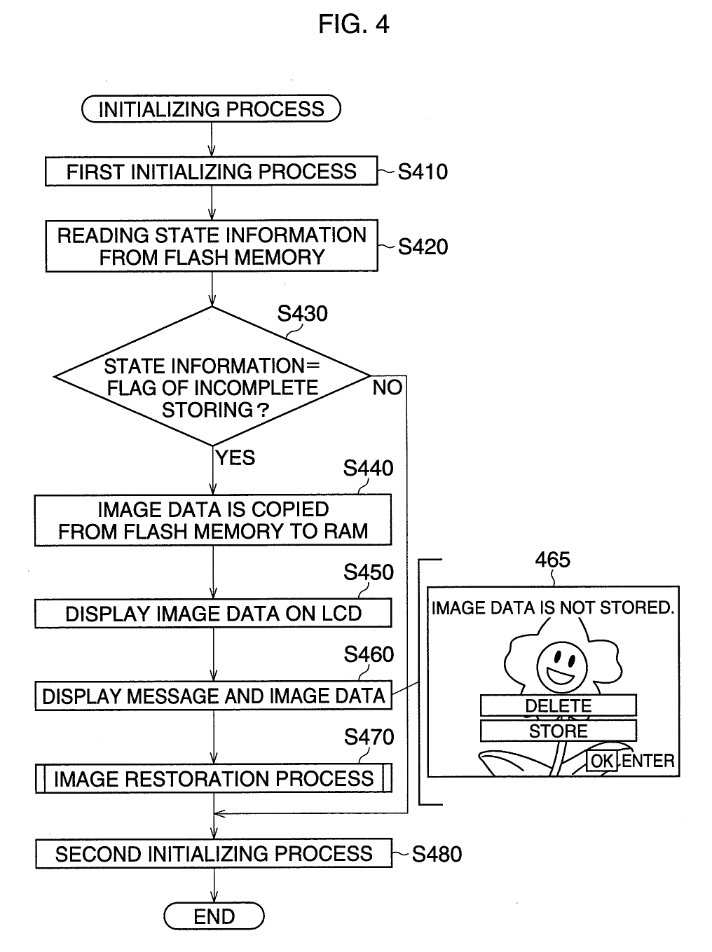

The initializing process of the digital camera is described below with reference to FIG. 4.

The initializing process is executed when the power supply of the digital camera is turned on by operating a power switch 181. The initializing process is comprised of the first and second initializing processes. The first initializing process is executed in step S410. In the first initializing process, the aperture of the digital camera is opened, the initial image is displayed on the LCD 160, the user-configured data is read from the flash memory 150, and the memory device is mounted to the DSP 130. In step S420, state information is read from the flash memory 150. In step S430, it is determined whether state information is stored in the flash memory 150. The second initializing process is executed in step S480 when state information is not stored; however, when state information is stored, the image data stored in the flash memory 150 is copied to the RAM 140 in step S440.

In step S450, the image data copied to the RAM 140 is displayed on the LCD 160. In step S460, the LCD 160 displays the image data along with a message requesting user confirmation as to whether the image data is to be stored in the external media, as depicted in the sample display 465. Next step in S470, after the image restoration process is executed according to the user's response to the confirmation message, the second initializing process is executed.

In the second initializing process, the photography subject provided by the CCD/AFE 120 is displayed directly on the LCD 160, and the switch mask disabling operation is released to enable the switch to be operated. At this point, all initializing processes are complete, and the digital camera is prepared for photographing.

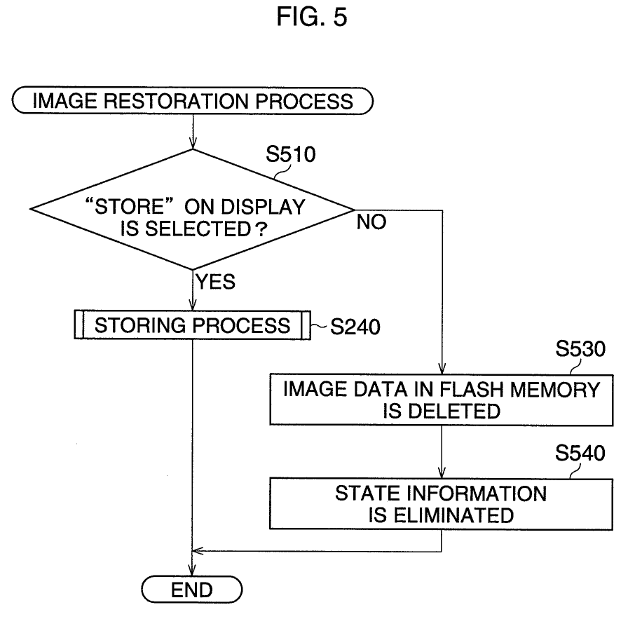

The image restoration process is described below with reference to FIG. 5.

According to the confirmation message displayed in step S460 of FIG. 4, a user makes a choice between either deleting the image from the memory 150 or storing the image into the external media, by operating a operation switch 182 connected to the DSP 130. The confirmation message is displayed simultaneously with the image data on the LCD 160, whereby it facilitates the selection of deletion or storage for the user. When storage is selected in step S510, the storing process is executed in step S240, which is the same storing as described in FIG. 3. When deletion is selected, the image data stored in the flash memory 150 is deleted in step S530, and state information is eliminated in step S540. The image restoration process is complete at this point. As a result, the image data may be stored into the external media 170 from the flash memory 150 without being lost.

Note that, when the image data is stored in the flash memory 150, the power supply of the digital camera need not be turned off in step S370 of FIG. 3. In this case, the processes from step S420 to S480 are executed according to either the inserted external media 170 or the existence of state information. The image data stored in the flash memory 150 is stored into the external media 170; making it possible for a user to avoid the trouble of operating the power supply of the digital camera so that a photograph can be taken immediately.

Note that the detach-sensing switch may be substituted by an open-sensing switch. The open-sensing switch 175 (refer to FIG. 1) positioned in a lid which is mounted on the body of the digital camera and covers the insert slot from the outside. The open-sensing switch 175 detects optically whether the lid is open or closed. When the open-sensing switch 175 detects an open lid, it transmits a signal indicating the open position through a control line to the DSP 130. The DSP 130 determines that the external media 170 is detached upon receipt of the signal indicating the open position.

Note that the external media may be the storage medium of memory cards, i.e. SD cards, hard disks, or solid state memory.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2006-127610 (filed on May 1, 2006), which is expressly incorporated herein, by reference, in its entirety.

1. The image-capturing apparatus comprising:
a memory included in the image-capturing apparatus;
a storage medium detachable from the image-capturing apparatus; and
an image recorder that stores image data into said memory in the case that said storage medium is detached during storage of input image data into said storage medium.

2. The image-capturing apparatus according to claim 1, wherein the power supply of the image-capturing apparatus is cut when said image recorder completes storing said image data into said memory.

3. The image-capturing apparatus according to claim 2, wherein the image data stored in said memory is stored into a recordable storage medium which is attached to the image-capturing apparatus when the power supply of the image-capturing apparatus is turned on.

4. The image-capturing apparatus according to claim 1, wherein state information indicates whether the image data is not stored in said storage medium, and when the image data is stored in said memory.

5. The image-capturing apparatus according to claim 4, wherein the power supply of the image-capturing apparatus is cut off upon completion of the storage of the image data and state information into said memory.

6. The image-capturing apparatus according to claim 5, wherein said image recorder stores the image data stored in said memory into said storage medium, if state information is stored in said memory when the power supply of the image-capturing apparatus turns on.

7. The image-capturing apparatus according to claim 4, wherein said image recorder stores the image data stored in said memory into said storage medium, if state information is stored in said memory when a recordable storage medium is attached to the image-capturing apparatus.

8. The image-capturing apparatus according to claim 1, wherein said image recorder stores the image data stored in said memory into said storage medium, according to the attachment of a recordable storage medium in the image-capturing apparatus.

9. The image-capturing apparatus according to claim 1 further comprises a storage selector for selecting whether said image recorder stores the image data that is stored in said memory into said storage medium or not.

10. The image-capturing apparatus according to claim 9 further comprises a display and an operating switch,
the storage selector displays a selector indication on said display indicating the choice of whether the image data is to be stored in said memory or in said storage medium, and provides selection information to said image recorder so that said image recorder stores the image data of said memory into said storage medium by operating said operating switch according to the selector indication.

11. The image-capturing apparatus according to claim 3, wherein said image recorder deletes the image data from said memory after storing the image data into said storage medium.

12. The image-capturing apparatus according to claim 1, wherein said storage medium comprises a detach detector which detects detachment of said storage medium from the image-capturing apparatus.

13. The image-capturing apparatus according to claim 12, wherein the detach detector is a switch disposed on a connecting portion of said storage medium.

14. The image-capturing apparatus according to claim 1, wherein said storage medium is a memory card.

15. The image-capturing apparatus according to claim 1, wherein said memory is a non-volatile rewritable memory.

16. The image-capturing apparatus according to claim 6, wherein said image recorder deletes the image data from said memory after storing the image data into said storage medium.

17. The image-capturing apparatus according to claim 7, wherein said image recorder deletes the image data from said memory after storing the image data into said storage medium.

18. The image-capturing apparatus according to claim 8, wherein said image recorder deletes the image data from said memory after storing the image data into said storage medium.
